(19) United States
(12) Patent Application Publication
(10) Pub. No.: US 2013/0115429 A1
(43) Pub. Date: May 9, 2013

(54) COMPOSITE STRUCTURE AND METHOD OF FORMING SAME

(71) Applicant: Luca Valle, Montreal (CA)

(72) Inventor: Luca Valle, Montreal (CA)

(73) Assignee: LEARJET, Wichita, KS (US)

(21) Appl. No.: 13/809,756

(22) PCT Filed: Jul. 13, 2010
(86) PCT No.: PCT/IB2010/001728

§ 371 Date: Jan. 11, 2013

(51) Int. Cl. B32B 37/22; B32B 3/08

(52) U.S. Cl. CPC B32B 37/22; B32B 3/08
USPC 428/172; 156/304.1

(57) ABSTRACT

A method of forming a composite structure having a skin, a plurality of webs and a plurality of flanges includes wrapping each of a plurality of first lay-ups around a corresponding one of a plurality of mandrels such that each first lay-up forms a skin section, a pair of opposed web sections, which extend from the skin section, and a pair of inwardly facing flange sections. The first lay-ups are aligned and a second lay-up is laid over their skin sections. A plurality of third lay-ups are laid over pairs of flange sections. A composite structure detained by this method is also disclosed.

### FIELD OF THE INVENTION

The present invention relates to a composite structure and a method of forming a composite structure.

### BACKGROUND OF THE INVENTION

It is known to reinforce extended surfaces with strengthening ribs and the like which stretch thereacross. These ribs, which can also be called stringers, are often parallel, or substantially parallel, and comprise a web extending substantially perpendicular from the extended surface and a flange which extends from an extremity of the web an angle thereto. This arrangement of web and flange can form a number of profiles, such as I-beams, T-beams, C-beams and the like.

Such a structure can be used in numerous fields and applications. In aeronautics, the extended surface can be a skin and the reinforced structure can be provided around the fuselage of an aircraft. Such a structure can also be used within an aircraft to form a floor.

In an aircraft, such structures can be formed from fiber-reinforced composites, such as carbon fiber-epoxy and the like. In such cases, the strengthening ribs are typically bonded, bolted and/or otherwise fastened to the extended surface.

U.S. Pat. No. 5,593,633, issued Jan. 14, 1997 to Dull et al. describes a vacuum-bagging arrangement wherein pairs of rubber blocks are used to form I-beam shaped stringers on top of a panel. U.S. Pat. No. 6,565,351, issued May 20, 2003 to Holsinger describes an apparatus for fabricating a composite structure that includes flexible hinge between two tooling portions.

Also known to the Applicant are the following related patents and/or patent applications: DE 102006031334, EP 1 151 856, EP 1 336 469, EP 1 888 323, EP 2 038 099, EP 2 038 107, U.S. Pat. No. 4,966,802, U.S. Pat. No. 5,170,967, U.S. Pat. No. 5,242,523, U.S. Pat. No. 5,593,633, U.S. Pat. No. 5,847,930, U.S. Pat. No. 6,375,121, U.S. Pat. No. 6,391,246, U.S. Pat. No. 6,508,909, U.S. Pat. No. 6,565,351, U.S. Pat. No. 6,589,472, U.S. Pat. No. 6,730,184, U.S. Pat. No. 6,743,504, U.S. Pat. No. 6,802,931, U.S. Pat. No. 7,527,222, U.S. Pat. No. 6,730,184, US 2007/0293110, WO 99/39976, WO 2001/15868, WO 2006/118691, WO 2006/136560, WO 2006/138025, WO 2008/003715, WO 2008/003767, WO 2009/111466, WO 2009/112694 and WO 2009/132892.

However, a drawback associated with some of the above-mentioned documents is that they require numerous steps to create an extended surface strengthened with stringers, which renders manufacture more complex and expensive. Another drawback associated with some of the above-mentioned documents is that they require mounting a pre-formed stringer onto an extended surface, which typically requires a large number of fasteners and can weaken the structure. This can require more complex, expensive tooling and can result in a heavier part.

It would be advantageous to provide a less complex reinforced composite structure. It would be advantageous to provide a composite structure including stringers which were integral with the structure's extended surface. It would also be advantageous to provide a composite structure which could be molded in one step.

### SUMMARY OF THE INVENTION

The present invention provides a method of forming a fiber-reinforced composite structure having a skin, a plurality of webs extending from the skin and a plurality of flanges, each flange extending from a respective web opposite the skin. The method includes the steps of:
a) wrapping each of a plurality of first lay-ups around a corresponding one of a plurality of mandrels, each first lay-up having opposed edges, each mandrel having four contiguous sides, each first lay-up wrapped such that it extends across three of the four contiguous sides and both opposed edges extend at least partially over the fourth side, each wrapped first lay-up forming:
   i) a skin section;
   ii) a pair of opposed web sections which extend from the skin section; and
   iii) a pair of inwardly facing flange sections, each of which extends from a respective web section and terminates in a respective one of the opposed edges;
b) aligning the first lay-ups side-by-side along their web sections on a first tool such that the flange sections face the first tool and the skin sections are exposed, each pair of adjacent web sections forming a one of the plurality of webs;
c) laying a second lay-up into a second tool and over the skin sections, the second lay-up and the skin sections forming the skin;
d) removing the first tool and exposing the flange sections; and
e) laying a plurality of third lay-ups over adjacent pairs of flange sections, each third lay-up and respective pair of flange sections forming a one of the plurality of flanges.

Preferably, the fiber-reinforced composite structure further includes at least one framing member which extends between two webs. At least one of the plurality of mandrels is assembled by:
a) providing first and second mandrel portions;
b) wrapping an extremity of each mandrel portion with a respective fourth lay-ups; and
c) aligning the first and second mandrel portions along their wrapped extremities, the adjacent fourth lay-ups forming the one of the at least one framing members.

Alternatively, the fiber-reinforce composite structure preferably further includes at least two framing members which extend between two webs. At least one of the plurality of mandrels is assembled by:
a) providing first, second and third mandrel portions;
b) wrapping an extremity of each of the first and second mandrel portions and two opposing extremities of the third mandrel portion with respective fourth lay-ups; and
c) aligning the wrapped first and second mandrel portions on either side of the third mandrel portion along their respective wrapped extremities, the adjacent fourth lay-ups between the first and third mandrels and the second and third mandrels forming two of the at least two framing members.

The present invention also provides a fiber-reinforced composite structure including:
a) a plurality of first lay-ups, each comprising a skin section, a pair of opposed web sections which extend from the skin section, and a pair of inwardly facing flange sections, each flange section extending from a respective web section, the first lay-ups being aligned side-by-side along their web sections;
b) a second lay-up laid over the skin sections; and
c) a plurality of third lay-ups laid over adjacent pairs of flange sections;
wherein the second lay-up and the skin sections form a skin, each pair of adjacent web sections form a web extending from the skin, and each third lay-up and respective pair of flange sections form a flange extending from a web opposite the skin.

### BRIEF DESCRIPTION OF THE DRAWINGS

The invention will be better understood upon reading the following non-restrictive description of the preferred embodiment thereof, made with reference to the accompanying drawings in which:

FIG. 1 is an exploded view including a composite structure in accordance with an embodiment the present invention.

FIG. 2 is a schematic cross-sectional view of the composite structure in FIG. 1.

FIGS. 3-9 illustrate a method of forming a composite structure in accordance with an embodiment of the present invention.

FIGS. 10a and 10b illustrate top views of structures formed according to the method of FIGS. 3-9.

FIGS. 11-14b illustrate a preferred method of assembling a mandrel in order to form framing members in accordance with the embodiment of FIG. 10b.

While the invention will be described in conjunction with an example embodiment, it will be understood that it is not intended to limit the scope of the invention to such embodiments. On the contrary, it is intended to cover all alternatives, modifications and equivalents as may be included as defined by the appended claims.

### DETAILED DESCRIPTION OF PREFERRED EMBODIMENTS OF THE INVENTION

In the following description, the same numerical references refer to similar elements. The embodiments shown in the figures are preferred, for exemplification purposes only.

In the context of the present description, the expression “ply” refers to an individual sheet of woven (or unidirectional) fiber. The plies referred to can be either pre-impregnated with resin or not. The expression “lay-up” refers to a grouping of one or more plies.

In addition, although the preferred embodiments of the present invention as illustrated in the accompanying drawings comprise various components, etc., and although the preferred embodiments of the structure and corresponding parts of the present invention as shown consist of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperation therebetween, as well as other suitable geometrical configurations may be used for the composite structure according to the present invention, as will be briefly explained herein and as can be easily inferred herefrom by a person skilled in the art, without departing from the scope of the invention.

It will be appreciated that the present invention may be practiced without some of the specific details which have been set forth herein below in order to provide a thorough understanding of the invention.

The method of the present invention is claimed and described herein as a series of steps. It will be understood that these steps may be performed in any logical order. Moreover, the method may be performed alone, or in conjunction with other procedures and methods before, during or after such methods and steps set forth herein without departing from the scope of the present invention.

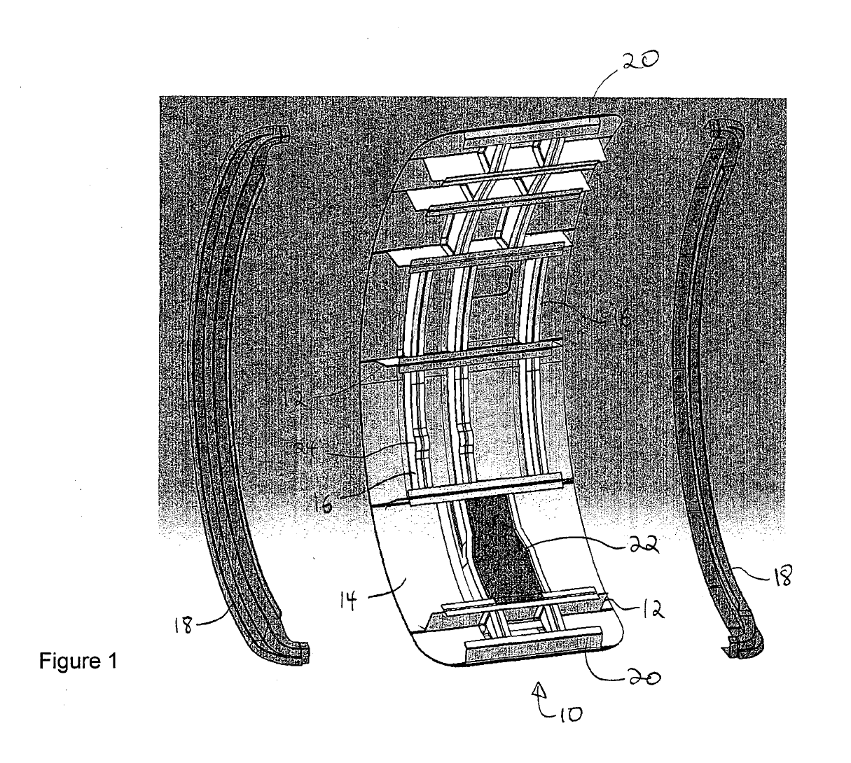

With reference to FIG. 1, a composite structure 10 comprises a plurality of substantially parallel primary stringers 12 which extend horizontally across a skin 14. Preferably, a plurality of secondary stringers 16 are also provided across the skin 14, extending perpendicularly to the primary stringers 12.

In the preferred embodiment illustrated, the composite structure 10 forms part of a door for an aircraft and the primary stringers 12, which may be referred to as intercostals, and secondary stringers 16, which can be referred to as framing members, are provided along the inside thereof. A pair of lateral frames 18 are bonded and/or otherwise fastened on either side of the structure 10. The lateral frames 18 form forward and aft seal strikers, while the top and bottom seal strikers 20 are formed as part of the structure 10.

The intercostals 12 and framing members 16 are arranged so as to accommodate various features of the door, such as a handle box 22, and contoured so as to accommodate the mechanical assembly, as at 24.

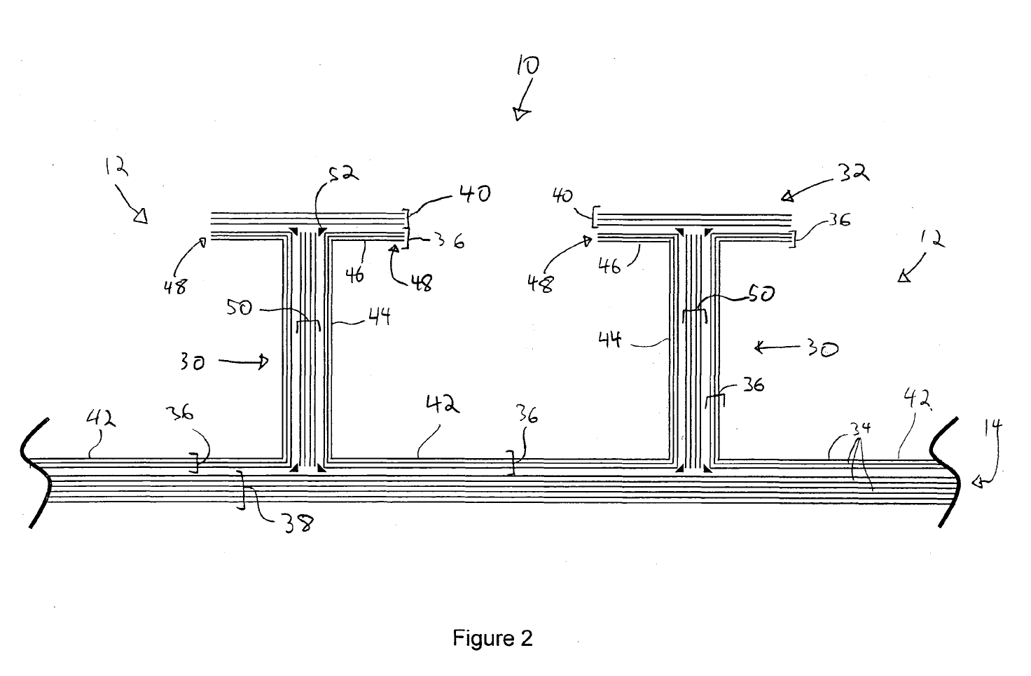

The intercostals 12 and framing members 16 are I-beam shaped in cross-section. With additional reference now to FIG. 2, a section of the structure 10 and the intercostals 12 are shown schematically in cross-section. Each intercostal 12 (two of which are illustrated) comprises a web 30 which extends outwards from the skin 14, and a flange 32 which extends on either side of the web 30 opposite the skin 14. As will be appreciated by one skilled in the art, the flanges 32 are substantially parallel to the skin 14 and the webs 30 extend perpendicularly therebetween, however as seen in FIG. 1, these elements may adopt more complex shapes in practice.

Each of the skin 14, the webs 30 and flanges 32 are formed from a plurality of plies 34. These are represented in FIG. 2 as individual lines. It will be appreciated that while the skin 14, web 30 and flanges 32 have been illustrated with nine, ten and six plies 34, respectively, various combinations are possible. As an example, the skin 14 may be composed of eight five-harness plies 34, one plain weave 34 and an outer layer of surfacing film (not shown).

The skin 14, webs 30 and flanges 32 are formed from a plurality of first lay-ups 36, a single second lay-up 38 and a plurality of third lay-ups 40. Each first lay-up 36, which is illustrated comprising three plies 34, comprises three distinct sections: a skin section 42, a pair of opposed web sections 44 which extend outward from the skin section 42, and a pair of inwardly facing flange sections 46, each of which extends from a respective one of the web sections 44. Each first lay-up 36 further comprises opposed edges 48 at the end of each flange section 46. FIG. 2 illustrates one whole first lay-up 36, portions of the first lay-ups 36 on either side thereof.

The second lay-up 38, only a portion of which is illustrated, extends underneath the skin sections 42 of the first lay-ups 36 (from the frame of reference of that figure). Together, the skin sections 42 and the second lay-up 38 form the skin 14. In the current embodiment, the first lay-up 36 represents about 25% of the skin 14.

The third lay-ups 40, two of which are illustrated, extend above the flange sections 46 of the first lay-up 36. Together, each third lay-up 40 and the adjacent pair flange sections 46 form the flanges 32.

The webs 30 are formed by the web sections 44 of adjacent first lay-ups 36. An additional lay-up, a middle blade 50, can be inserted between the adjacent web sections 44 in order to adjust the thickness of the webs 30. Moreover, a middle blade 50 can be used to tailor thickness to follow load distribution, while ensuring local symmetry.

As will be appreciated by one skilled in the art, a plurality of noodles 52 are preferably positioned along any bends in the lay-ups, i.e. along the junctions between the skin and web sections 42 and 44, and the web and flange sections 44 and 46.

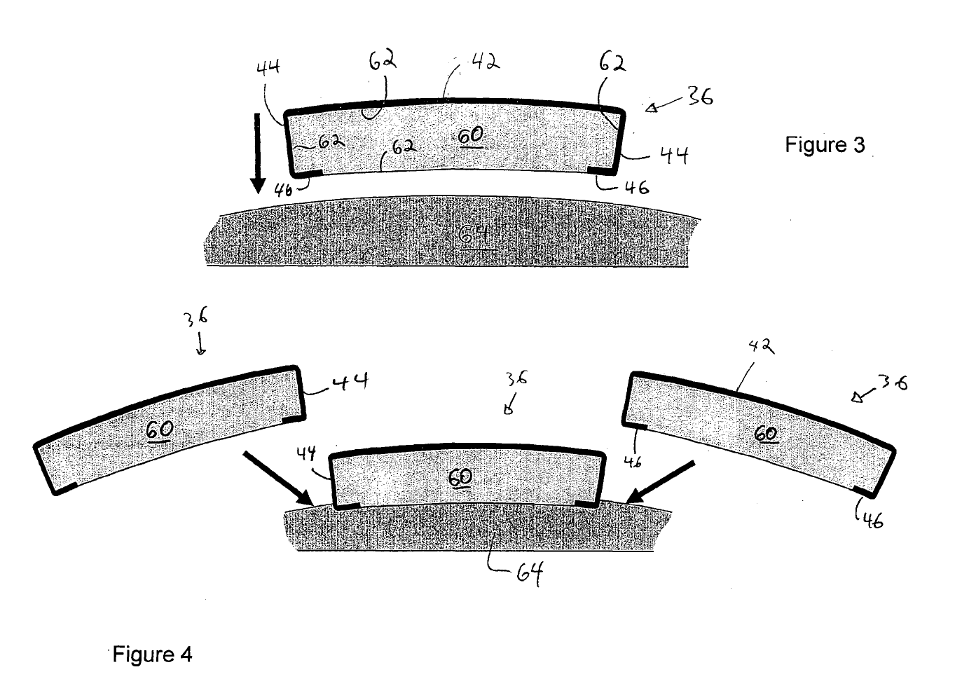

With reference now to FIGS. 3-10, a method of forming the composite structure 10 will be described.

As seen in FIG. 3, each of the plurality of first lay-ups 36 are formed by wrapping a mandrel 60 with the appropriate number of plies 34 (all shown in cross-section). The mandrel 60 has four contiguous sides 62 which define and support the sections 42, 44 and 46 of the first lay-up 36 during curing. The skin section 42 and the pair of web sections 44 extend across three of the four sides 62, while the flange sections 46 extend partially over the fourth. As such, the first lay-up 36 forms an incomplete rectangular tube.

In practice, it may be desirable to provide first lay-ups 36 which are longer than will ultimately be necessary in the composite structure 10. In this case, the flange sections 46 will extend farther around the fourth side 62. Such excess sections are then cut and the outer edges of each flange section 46 are polished to ensure a proper finish. The degree to which the flange sections 46 are extended can vary, although they are preferably not so long as to overlap.

Although trimming the cured flange sections 46 requires and additional step in the manufacturing process, it will be appreciated that the first lay-ups 36 advantageously do not need to be positioned quite as precisely as they would have otherwise given that the excess will subsequently be cut off, thereby ensuring precise dimensions of the final flange sections 46. However, it will also be appreciated that this results in an increased scrap rate.

For simplicity however, the schematic representation illustrated in the figures does not include such extensions. It will also be appreciated that this technique of extending lay-ups so as to be later able to trim and polish them can similarly be applied elsewhere.

As seen in FIG. 4, the mandrel-wrapped first lay-ups 36 are aligned side-by-side along their web sections 44 on a first tool 64, such that their skin sections 42 are exposed and their flange sections 46 are facing the tool 64. In the illustrated embodiment, the tool 64 is a male tool, so as to form the curved shape seen in FIG. 1. If middle blades 50 are to be used, it is at this stage that they are inserted between adjacent web sections 44.

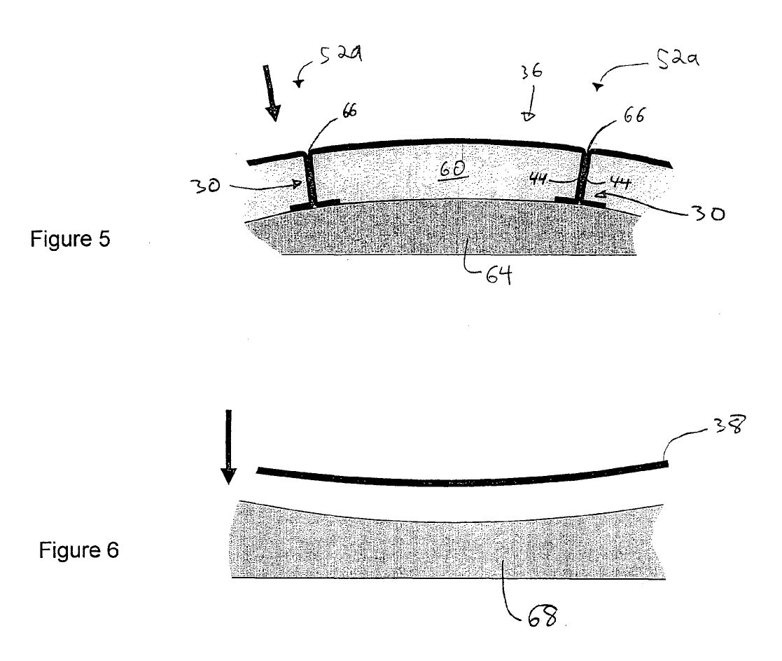

As seen in FIG. 5, each pair of web sections 44 now forms a web 30. A first set of the noodles 52a is positioned along the exposed junctions 66 between adjacent web and skin sections 44 and 42.

As seen in FIG. 6, the second lay-up 38 is positioned into a second tool 68. In the illustrated embodiment, the second tool 68 is a female tool.

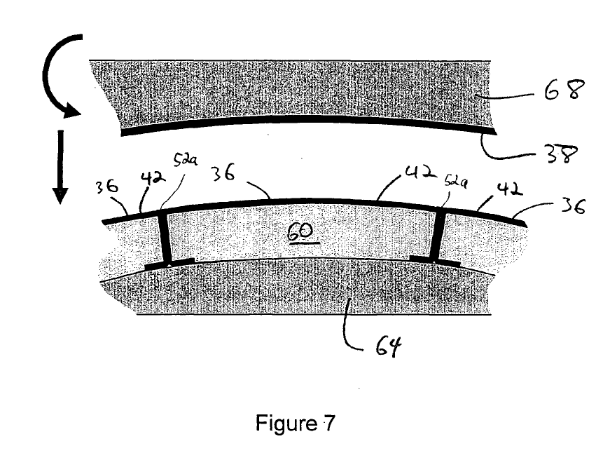

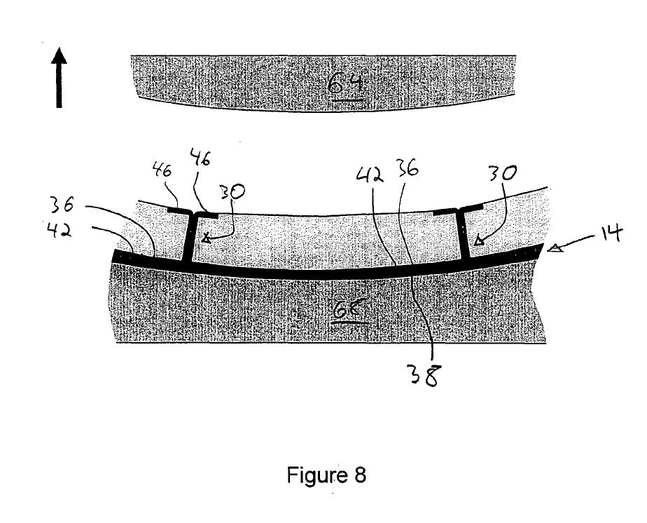

As seen in FIGS. 7 and 8, the second lay-up 38 is then placed across the aligned skin sections 42 of the first lay-ups 36 and the male tool 64 is removed, thereby exposing the flange sections 46. The second lay-up 38 and the skin sections 42 now form the skin 14.

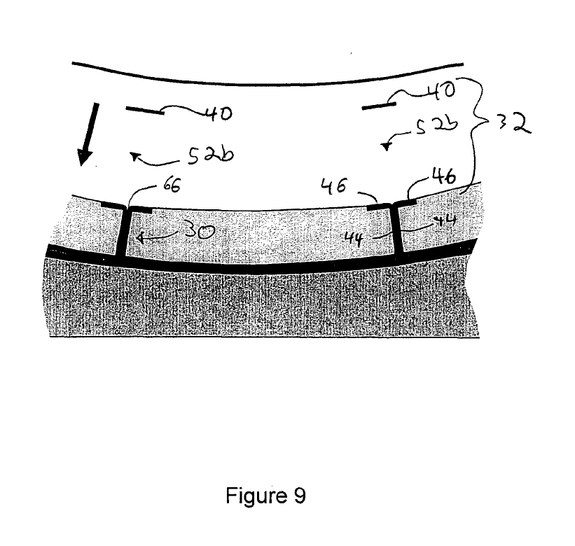

As seen in FIG. 9, a second set of noodles 52b is positioned along the exposed junctions 66 between adjacent web and flange sections 44 and 46. The third lay-ups 40 are then laid over adjacent pairs of flange sections 46, thereby forming the flanges 32.

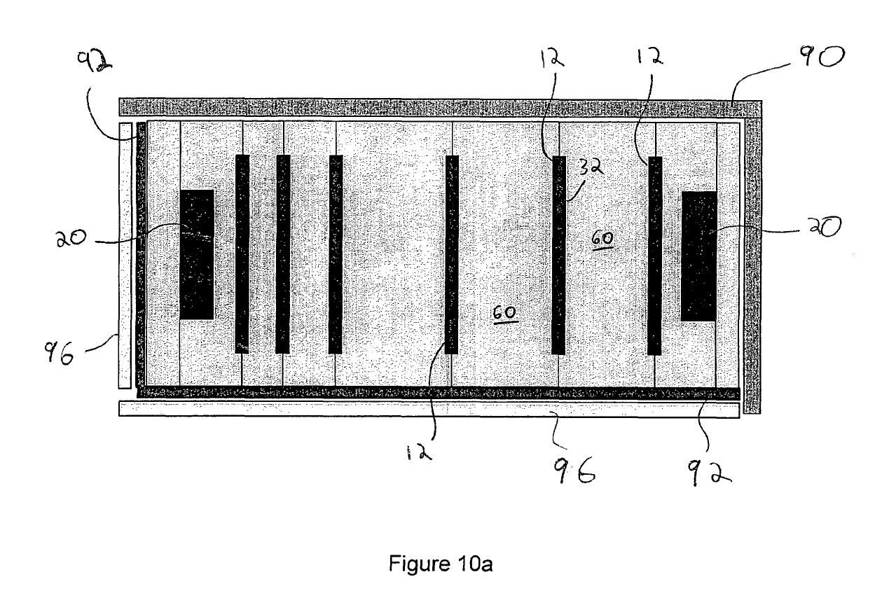

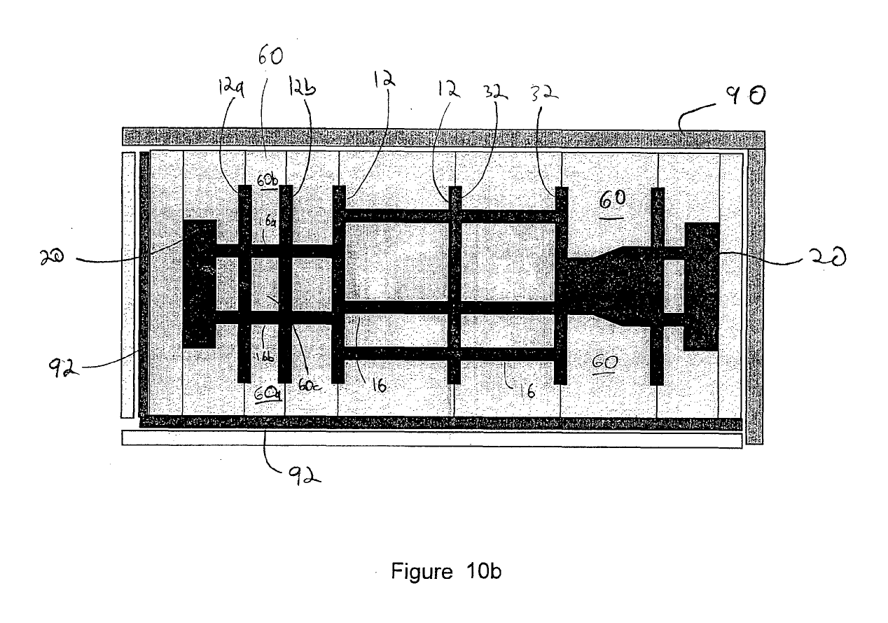

As seen in FIG. 10a, which shows the now assembled first, second and third lay-ups 36, 38 and 40 from above, a variety of differently sized and shaped mandrels 60 are used to form a composite structure 10.

It will be appreciated that because resin will liquefy during the cure cycle, it is desirable to constrain the mandrels 60 in order ensure the proper alignment of the lay-ups 36, 38 and 40. A tool frame 90 is therefore preferably provided to index the mandrels 60 and lay-ups 36, 38 and 40 with respect to the tools 64 and 68.

In the illustrated embodiment, the tool frame 90, functioning as a datum, extends along two perpendicular sides of the assembly and pressure is applied opposite the tool frame. Pressure can be applied by combining vacuum, autoclave and intensifiers 92 installed along the sides 96. Alternatively, a variation of the tool frame 90 could be used which extends along one longitudinal side of the assembly and pins one or more mandrels in place while pressure is applied along the remaining three sides. It will be appreciated however that various other means for maintaining alignment during the cure cycle are possible.

However, the composite structure of FIG. 10a, in contrast with that shown in FIG. 1, does not comprise any framing members 16. With reference now to FIG. 10b, these members 16, which extend perpendicularly between the webs 30 of two intercostals, can be formed using a multi-piece mandrel 60 if and when such a structure is desired.

For example, the framing members 16a and 16b extend between the intercostals 12a and 12b. In order to enable the formation and co-curing of these framing members 16a and 16b, the mandrel 60 which separates the two intercostals 12a and 12b is assembled in three portions 60a, 60b and 60c.

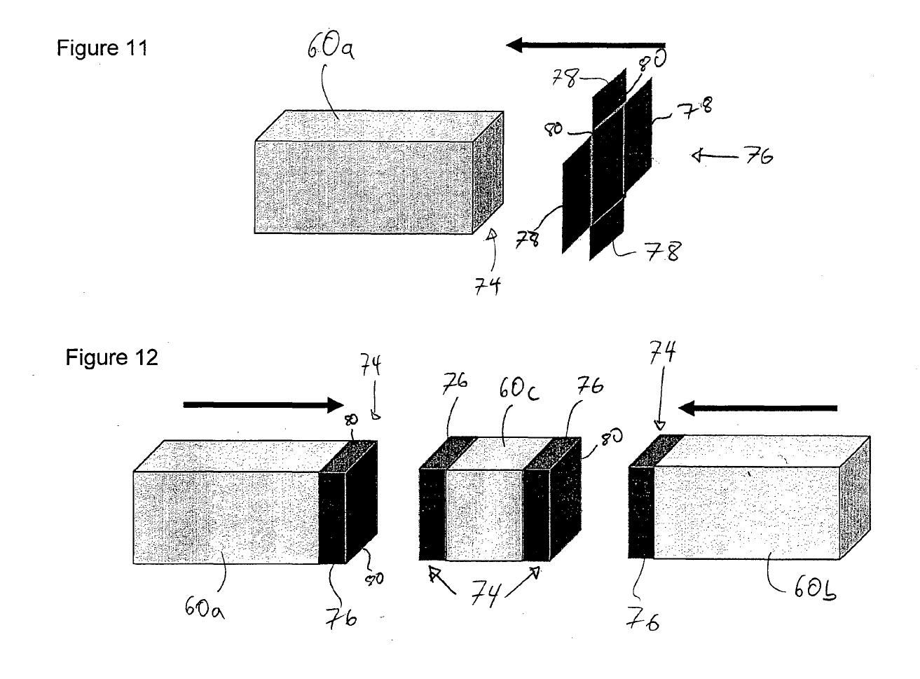

As seen in FIGS. 11 and 12, an extremity 74 of each of the first and second mandrel portions 60a and 60b is wrapped with a fourth lay-up 76, while two opposing extremities 74 of the third mandrel section 60c are similarly wrapped with fourth lay-ups 76. In the embodiment illustrated, the unwrapped fourth lay-up 76 is provided with two pairs of opposed flaps 78 which wrap around the extremity 74. The upper flaps can be folded back along fold lines 80 to form a flange similar to the flange 32 of the intercostals 12, while the lower flap can provide a surface for bonding the framing member 16 to the skin section 42 of the first lay-up 36. The left and right flaps 78 can provide a surface for bonding the framing members 16 to the webs 30.

The mandrel 60 is then assembled, and the framing members 16 formed, by aligning the first and second mandrel portions 60a and 60b on either side of the third mandrel portion 60c along their respective wrapped extremities 74. As before, middle blades 50 can be inserted between the fourth lay-ups 76 in order to adjust the thickness of the framing members.

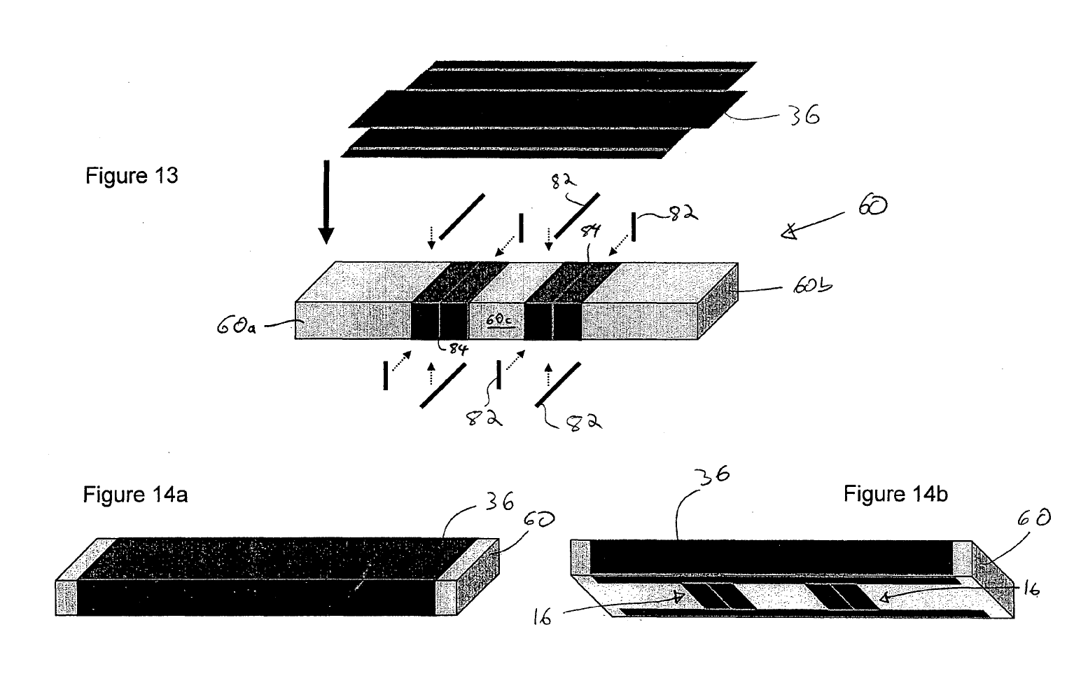

As seen in FIG. 13, noodles 82 are positioned along the exposed junctions 84 along the fold lines 80 between adjacent fourth lay-ups 76. Subsequently, and as seen in FIG. 14a, the first lay-up 36 is wrapped around the assembled mandrel 60. As seen in FIG. 14b, the framing members are therefore formed within the mandrel 60, between the mandrel portions 60a, 60b and 60c. A plurality of wrapped mandrels 60 is then aligned in a similar fashion as described above and shown in FIG. 3 and following.

It will be appreciated that in situations where a single framing member 16 is present between two intercostals 12, a mandrel 60 comprising two mandrel portions 60a and 60b could similarly be used by omitting the central third mandrel portion 60c. It will similarly be appreciated that a multi-piece mandrel arrangement could also be used for embodiments comprising three or more framing members 16 between a pair of intercostals 12 by providing an appropriate number of mandrel portions 60a, 60b, 60c, 60d, etc.

Once the assembly has been cured, the mandrels 60 can be removed. For rows including either one framing member 16 or none at all, the mandrel 60 or mandrel portions 60a and 60b can simply be slid out of the now rigid structure 10. For rows having two or more framing members, the multi-part mandrels 60, such as that illustrated in FIGS. 11-14b, will include one or more the central mandrel portions 60c which are constrained by the first and fourth lay-ups 36 and 76 in all directions. As such, the central mandrel portions 60c are preferably deformable so as to enable their removal. Various types of deformable mandrels 60c are known in the art, such as collapsible mandrels, deflatable bladder mandrels and dissolvable mandrels, although it will be appreciated that this list should be considered in no way limiting.

As being now better appreciated, the present invention is an improvement and presents several advantages over other related devices and/or methods known in the prior art. Indeed, the present invention is particularly advantageous in that the structure 10 requires only one curing cycle which can simplify construction and therefore avoid the need for mechanical fasteners between the stringers 12 and the skin 14, or indeed between the framing members 16 and the skin 14 should the former be included as well. This, it will be appreciated, can reduce the final part's complexity and weight and ease its assembly. A structure 10 in accordance with the present invention can also be formed with pre-impregnated plies 34, thereby avoiding the need for resin transfer molding. In addition, a structure 10 assembled according to an embodiment of the present invention enables integrated tooling so there is no need to transfer from one laminate surface to another.

Of course, numerous modifications could be made to the above-described embodiments without departing from the scope of the invention, as apparent to a person skilled in the art.

While specific embodiments of the present invention have been described and illustrated, it will be apparent to those skilled in the art that numerous modifications and variations can be made without departing from the scope of the invention.

1. A method of forming a fiber-reinforced composite structure having a skin, a plurality of webs extending from the skin and a plurality of flanges, each flange extending from a respective web opposite the skin, the method comprising the steps of:
a) wrapping each of a plurality of first lay-ups around a corresponding one of a plurality of mandrels, each first lay-up comprising opposed edges, each mandrel having four contiguous sides, each first lay-up wrapped such that it extends across three of the four contiguous sides and both opposed edges extend at least partially over the fourth side, each wrapped first lay-up forming:
i) a skin section;
ii) a pair of opposed web sections which extend from the skin section; and
iii) a pair of inwardly facing flange sections, each of which extends from a respective web section and terminates in a respective one of the opposed edges;
b) aligning the first lay-ups side-by-side along their web sections on a first tool such that the flange sections face the first tool and the skin sections are exposed, each pair of adjacent web sections forming a one of the plurality of webs;
c) laying a second lay-up into a second tool and over the skin sections of the first lay-ups, the second lay-up and the skin sections of the first lay-ups forming the skin;
d) removing the first tool and exposing the flange sections; and
e) laying a plurality of third lay-ups over adjacent pairs of flange sections of the first lay-ups, each third lay-up and respective pair of flange sections of the first lay-ups forming a one of the plurality of flanges.

2. The method of claim 1, wherein the step b) further includes inserting a middle blade lay-up between each pair of adjacent web sections of the first lay-ups.

3. The method of claim 1, wherein the following step is performed between steps b) and c): inserting a noodle along each exposed junction between adjacent web and skin sections.

4. The method of claim 1, wherein the following step is performed between steps d) and e): inserting a noodle along each exposed junction between adjacent web and flange sections.

5. The method of claim 1, further including, subsequent to step e), the step of curing the composite structure.

6. The method of claim 1, further including, subsequent to step e), the step of removing the plurality of mandrels.

7. The method of claim 1, wherein the fiber-reinforced composite structure further includes at least one framing member which extends between two webs, wherein at least one of the plurality of mandrels is assembled by:
a) providing first and second mandrel portions;
b) wrapping an extremity of each mandrel portion with a respective fourth lay-ups; and
c) aligning the first and second mandrel portions along their wrapped extremities, the adjacent fourth lay-ups forming the one of the at least one framing members.

8. The method of claim 1, wherein the fiber-reinforce composite structure further includes at least two framing members which extend between two webs, wherein at least one of the plurality of mandrels is assembled by:
a) providing first, second and third mandrel portions;
b) wrapping an extremity of each of the first and second mandrel portions and two opposing extremities of the third mandrel portion with respective fourth lay-ups; and
c) aligning the wrapped first and second mandrel portions on either side of the third mandrel portion along their respective wrapped extremities, the adjacent fourth lay-ups between the first and third mandrels and the second and third mandrels forming two of the at least two framing members.

9. The method of claim 1 wherein the first tool is a male tool and the second tool is a female tool.

10. The method of claim 7, further comprising the step of inserting noodles along the exposed junctions between the fourth lay-ups.

11. The method of claim 8, further comprising the step of inserting noodles along the exposed junctions between the fourth lay-ups.

12. The method of claim 8, wherein the third mandrel portion is made of a deformable material.

13. The method of claim 1, further comprising the step of framing the mandrels with a tool frame.

14. A fiber-reinforced composite structure comprising:
a) a plurality of first lay-ups, each comprising a skin section, a pair of opposed web sections which extend from the skin section, and a pair of inwardly facing flange sections, each flange section extending from a respective web section, the first lay-ups being aligned side-by-side along their web sections;
b) a second lay-up laid over the skin sections; and
c) a plurality of third lay-ups laid over adjacent pairs of flange sections;
wherein the second lay-up and the skin sections form a skin, each pair of adjacent web sections form a web extending from the skin, and each third lay-up and respective pair of flange sections form a flange extending from a web opposite the skin.

15. The fiber-reinforced composite structure of claim 14, further comprising a plurality of middle blade lay-ups positioned between adjacent web sections.

16. The fiber-reinforced composite structure of claim 14, further comprising noodles positioned between the second lay-up and the junctions between adjacent web and skin sections.

17. The fiber-reinforced composite structure of claim 14, further comprising noodles positioned between each third lay-up and the junctions between adjacent web and flange sections.

18. The fiber-reinforced composite structure of claim 14, further comprising at least one framing member extending between two webs.

19. The fiber-reinforced composite structure of claim 14, further comprising seal strikers at either end of the composite structure.
